(19) United States
(12) Patent Application Publication
(10) Pub. No.: US 2026/0053288 A1
(43) Pub. Date: Feb. 26, 2026

(54) 3 In 1 Baby Spoon

(71) Applicant: AnnMarie Williams, Bowie, MD (US)

(72) Inventor: AnnMarie Williams, Bowie, MD (US)

(21) Appl. No.: 18/810,447

(22) Filed: Aug. 20, 2024

Related U.S. Application Data
(60) Provisional application No. 63/533,669, filed on Aug. 20, 2023.

(51) Int. Cl. A47G 21/04; A61J 17/00

(52) U.S. Cl. CPC A47G 21/04; A61J 17/10

(57) ABSTRACT

A 3 in 1 baby utensil including an elongated member having a handle, a first end and a second end. A plurality of ridges extending along the handle between the first end and the second end. A food gathering portion disposed at the first end. A teething device disposed at the second end.

### CROSS REFERENCE TO RELATED APPLICATIONS

This application claims the benefit of U.S. Provisional Application Ser.

No. 63/533,669, filed on Aug. 20, 2023, which is hereby incorporated by reference in its entirety.

### PRIOR ART

While there are other baby utensils and teething devices on the market such as US 2,338,980, US 2007/0251103, US 2007/015111, and US 2004/0215234, however, there aren't any baby utensils that act as teething devices with a non-slip grip and brightly colored animal heads to help facilitate child interactions.

More specifically, U.S. Pat. No. 2,338,980 does not include a teether on the device while the present subject matter has a brightly colored grip with 13 non-slip ridges on the side to promote grasping skills and prevent the baby's tiny hands from slipping off the utensil.

US 2007/015111 has different relative firmness to the utensil throughout and lacks a teething component, whereas the present subject matter has consistent firmness throughout the handle and bowl. Furthermore, the present subject matter is made from food-grade silicone.

US 2007/0251103 does not have a teething component to the utensil and lacks the same non-slip ridges the present subject matter has which allows the child to hold onto the utensil.

US 2004/0215234 is only a teething device and suitable for use as a spoon.

### SUMMARY OF THE INVENTION

A 3 in 1 baby utensil including an elongated member having a handle, a first end and a second end. Aa plurality of ridges extending along the handle between the first end and the second end. A food gathering portion disposed at the first end. A teething device disposed at the second end.

A 3 in 1 baby utensil including an elongated member having a handle, a first end and a second end. A plurality of ridges extending along the handle between the first end and the second end. The plurality of ridges provide a non-slip surface and each ridge includes a width. A food gathering portion disposed at the first end. A teething device disposed at the second end.

A method of manufacture of a 3 in 1 baby utensil includes molding an elongated member having a handle, a first end and a second end. forming a plurality of ridges extending along the handle between the first end and the second end. Molding a food gathering portion at the first end. Molding a teething device at the second end.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### DESCRIPTION OF DRAWINGS

FIG. 1 shows a top view of 3-in-1 bay utensil according to one embodiment of the present disclosure.

FIG. 2 shows a side view of 3-in-1 utensil according to one embodiment of the present disclosure.

FIG. 3 shows a top view of 3-in-1 utensil according to one embodiment of the present disclosure.

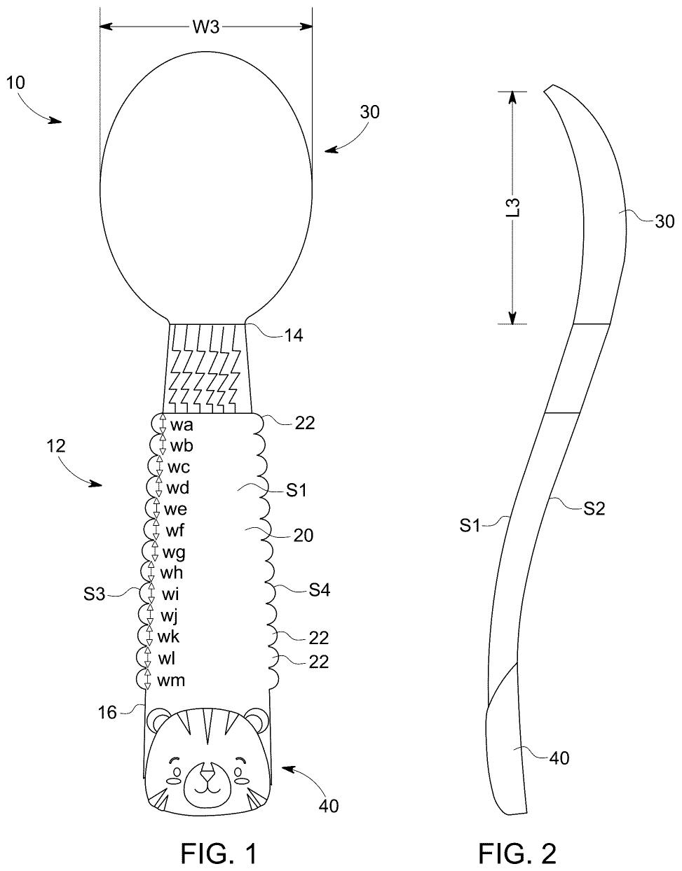

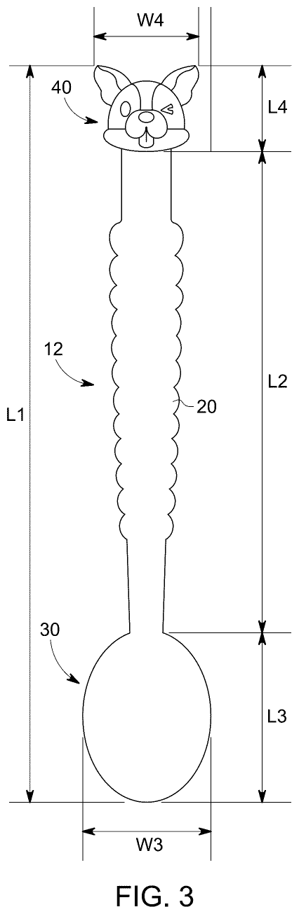

### DETAILED DESCRIPTION OF THE INVENTION

Traditionally, baby utensils have served the sole purpose of delivering food from bowl to mouth. However, the 3-in-1 baby feeding utensil, as described herein, takes this basic functionality to a whole new level. It's not just a utensil; it's a multifaceted tool designed to enhance the feeding experience in multiple ways. The 3-in-1 utensil, for example a spoon, for a baby as disclosed herein will become better understood through a review of the following detailed description in conjunction with the figures.

The detailed description and figures provide merely examples of the various embodiments of a three in one baby utensil. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

The 3-in-1 baby feeding utensil, for example, spoon 10 includes an elongated member 12. Member 12 extends between an end 14 and an end 16. Member 12 includes a length L1. In some embodiments, the length L1 is approximately 145.0 mm. Member 12 includes a handle portion 20. Handle portion 20 includes a length L2. In some embodiments, length L2 is approximately 90.5 to 94.0 mm. Handle portion 20 includes a top surface S1, a bottom surface S2 and side surfaces S3, S4. Top surface S1 and bottom surface S2 are substantially planar. Side surfaces S3, S4 include a plurality of ridges 22. Ridges 22 provides a non-slip surface. Ridges 22 each include a width Wa, Wb, Wc, Wd, We, Wf, Wg, Wh, Wi, Wj, Wk, Wl, Wm. The widths of each ridge 22 gradually increase along length L2. The increasing width of ridges 22 are configured to accommodate for a child's growing hands and designed to make hand-to-mouth coordination more successful while promoting independence in self-feeding. Member 12 is made of a material that allows the child to chew on member 12 portion. Member 12 is configured to facilitate jaw strength for appropriate biting and chewing to support atypical babies and toddlers.

Member 12 includes a food gathering portion, for example, a scoop 30. Scoop 30 is configured to transfer food from a food dish to a child's mouth.

Scoop 30 includes a length L3 and a width W3. In some embodiments, length L3 is approximately 34.0 mm and width W3 is approximately 25.0 mm. The length L3 and width W3 of scoop 30 are configured such that scoop 30 fits safely into the mouth of a small child. Portion 30 is shallow and is configured to facilitate a child's transfer of food without much spillage and promotes lip closure with the upper lip removing the food from the spoon. The shallow bowl of the spoon makes it easy to transfer the food from the bowl of the spoon into the mouth. It is very sturdy and easy for tiny hands to manage, so there will be no spillage during the feeding process. The food stays on the spoon because of the effectiveness of the built-up super grip handle. Its shape and size facilitate easy scooping during feeding. It is made from 100% food-grade silicone, therefore, ensuring no irritation to the baby's sore teething gum. The shape of teething portion is configured to stimulate the gums of the child to facilitate soothing of the gums during teething.

Member 12 includes a teething portion end 40. Teething portion end 40 includes an animal head design. End 40 includes a length L4 and a width W4. In some embodiments, length L4 is between approximately 16 mm and 21 mm. In some embodiments, width w4 is between approximately 19 mm and 21 mm. End 40 is configured with bright, colorful, fun, and playful animal characters that excite and motivate the child. The bright colors are motivating and keep babies and toddlers'attention throughout mealtime.

The animal heads at the end of the utensil may include, for example, ducks, cats, dogs, and cows. However, any other type of animal may be chosen for the teething portion.

The chewy tube facilitates jaw strength for appropriate biting and chewing to support atypical babies and toddlers. The scoop fits perfectly into the mouth and is sturdy and easy to transfer the food into the child's mouth.

The 3-in-on utensil is made using 100% silicone to allow for safe use during eating and teething. The 3-in-one utensil includes a consistent firmness throughout the elongated portion and portion 30. Furthermore, the present subject matter is made from food-grade silicone.

Like any standard spoon, the 3-in-1 utensil excels at delivering purees, cereals, and other baby foods with ease. Our perfect scoop bowl minimizes spillage, keeping mealtimes mess-free and enjoyable. One of the improved features of the 3-in-1 baby utensil is its ability to soothe sore gums during the teething phase. The utensil's textured surface provides gentle relief to aching gums, turning feeding time into a comforting experience for your little one.

Beyond its practical functions, the 3-in-1 utensil is designed to promote developmental milestones in babies. By incorporating fun animal character heads and vibrant colors, these spoons stimulate baby's senses and encourage self-feeding, motor skill development, and feeding independence. Mealtime becomes an engaging activity where learning and exploration go hand in hand.

The 3-in-1 utensil includes three essential tools in one compact package, eliminating the need for multiple feeding accessories cluttering your kitchen drawer. The 3-in-1 utensil is safe as the utensil is made from high-quality, non-toxic materials, ensuring a worry-free feeding experience for parents. The 3-in-1 utensil is built to last. The 3-in-1 utensil includes a sturdy construction, and fade-resistant colors mean it can withstand the rigors of daily use and multiple washes, making it the only spoon you'll need until your little one outgrows it. The 3-in-1 utensil transforms mealtime into a fun and interactive experience. The 3-in-1 baby spoon fosters positive associations with food and promotes healthy eating habits from an early age.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

1. A 3 in 1 baby utensil comprising:
an elongated member having a handle, a first end and a second end, a plurality of ridges extending along the handle between the first end and the second end;
a food gathering portion disposed at the first end; and
a teething device disposed at the second end.

2. The 3 in 1 baby utensil of claim 1, wherein the plurality of ridges provide a non-slip surface and each ridge includes a width.

3. The 3 in 1 baby utensil of claim 2, wherein each ridge width increases along the handle between the first to the second end.

4. The 3 in 1 baby utensil of claim 1, wherein the ridges promote grasping skills and facilitate holding the utensil.

5. The 3 in 1 baby utensil of claim 1, wherein the handle includes a top planar surface and a bottom planar surface and the plurality of ridges extend along a first side and a second side of the handle between the top planar surface and the bottom planar surface.

6. The 3 in 1 baby utensil of claim 1, wherein the elongated member includes a consistent firmness throughout its length.

7. The 3 in 1 baby utensil of claim 1, wherein the elongated member includes a length of approximately 145.0 mm.

8. The 3 in 1 baby utensil of claim 1, wherein the handle includes a length of approximately 90.5 mm to 94.0 mm.

9. The 3 in 1 baby utensil of claim 1, wherein the food gathering portion includes a scoop.

10. The 3 in 1 baby utensil of claim 8, wherein the scoop includes a length of approximately 34.0 mm and a width of approximately 25.0 mm.

11. A 3 in 1 baby utensil comprising:
an elongated member having a handle, a first end and a second end, a plurality of ridges extending along the handle between the first end and the second end, the plurality of ridges provide a non-slip surface and each ridge includes a width;
a food gathering portion disposed at the first end; and
a teething device disposed at the second end.

12. The 3 in 1 baby utensil of claim 11, wherein the ridges promote grasping skills and facilitate holding the utensil.

13. The 3 in 1 baby utensil of claim 11, wherein the handle includes a top planar surface and a bottom planar surface and the plurality of ridges extend along a first side and a second side of the handle between the top planar surface and the bottom planar surface.

14. The 3 in 1 baby utensil of claim 11, wherein the elongated member includes a consistent firmness throughout its length.

15. The 3 in 1 baby utensil of claim 11, wherein the elongated member includes a length of approximately 145.0 mm.

16. The 3 in 1 baby utensil of claim 11, wherein the handle includes a length of approximately 90.5 mm to 94.0 mm.

17. The 3 in 1 baby utensil of claim 11, wherein the food gathering portion includes a scoop.

18. The 3 in 1 baby utensil of claim 17, wherein the scoop includes a length of approximately 34.0 mm and a width of approximately 25.0 mm.

19. A 3 in 1 baby utensil comprising:
an elongated member having a handle, a first end and a second end, a plurality of ridges extending along the handle between the first end and the second end, the plurality of ridges provide a non-slip surface and each ridge includes a width each ridge width that increases along the handle between the first to the second end. ;
a food gathering portion disposed at the first end; and
a teething device disposed at the second end.

20. A method of manufacture of a 3 in 1 baby utensil comprising:
molding an elongated member having a handle, a first end and a second end;
forming a plurality of ridges extending along the handle between the first end and the second end;
molding a food gathering portion at the first end; and
molding a teething device at the second end.
